(19) United States
(12) Patent Application Publication
(10) Pub. No.: US 2015/0119056 A1
(43) Pub. Date: Apr. 30, 2015

(54) METHOD OF DEVICE-TO-DEVICE COMMUNICATION AND METHOD OF CONTROLLING DEVICE-TO-DEVICE COMMUNICATION

(71) Applicant: ELECTRONICS AND TELECOMMUNICATIONS RESEARCH INSTITUTE, Daejeon (KR)

(72) Inventors: Kyoung Seok LEE, Daejeon (KR); Taegyun NOH, Daejeon (KR); Choongil YEH, Daejeon (KR); Jae Young AHN, Daejeon (KR)

(73) Assignee: ELECTRONICS AND TELECOMMUNICATIONS RESEARCH INSTITUTE, Daejeon (KR)

(21) Appl. No.: 14/527,551

(22) Filed: Oct. 29, 2014

(30) Foreign Application Priority Data
Oct. 30, 2013 (KR) 10-2013-0130492
Sep. 18, 2014 (KR) 10-2014-0124610

(51) Int. Cl. H04W 56/00; H04W 72/00; H04W 72/04

(52) U.S. Cl. CPC H04W 56/001; H04W 72/0406; H04W 72/005
USPC 455/450

(57) ABSTRACT

A first terminal within a first cell of a first base station receives a synchronization signal and a synchronization channel that are broadcasted through a downlink by the first base station. The first terminal acquires synchronization for D2D communication using the synchronization signal and the synchronization channel. When the first terminal is connected to the first base station, in order to request allocation of a first resource for D2D communication, the first terminal transmits first information for D2D communication to the first base station through a first data channel for cellular communication. The first terminal receives D2D control information including information about the first resource that is allocated to the first terminal from the first base station. The first terminal broadcasts a second data channel for D2D communication using the D2D control information.

### CROSS-REFERENCE TO RELATED APPLICATION

This application claims priority to and the benefit of Korean Patent Application Nos. 10-2013-0130492 and 10-2014-0124610 filed in the Korean Intellectual Property Office on Oct. 30, 2013 and Sep. 18, 2014, the entire contents of which are incorporated herein by reference.

### BACKGROUND OF THE INVENTION

(a) Field of the Invention

The present invention relates to D2D communication in which a terminal directly communicates with another terminal.

(b) Description of the Related Art

In a communication environment in which a mobile communication network is constructed based on a base station, research on setting a radio path for direct communication between geographically adjacent terminals and using the radio path in communication has been performed.

Direct communication between terminals, i.e., D2D communication, is communication between terminals without going through a base station (relay of a base station), as a terminal wirelessly transmits data and another terminal directly receives the data. D2D communication is performed using a radio resource and may use a frequency of a licensed band.

Mobile communication is performed based on a base station. A terminal that is located in coverage of a cell that is constructed based on a base station may perform D2D communication while receiving the control of the base station.

Further, because D2D communication can be directly performed between terminals, a terminal that is located out of coverage of a cell may perform D2D communication even without the control of a base station.

Further, because terminals that are located at the cell boundary may perform D2D communication, a terminal that is located in coverage of a cell and a terminal that is located out of coverage of a cell should be able to perform D2D communication.

Terminals participating in D2D communication should maintain time and frequency synchronization, and a synchronization procedure for this is requested.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method in which a terminal performs D2D communication in coverage of a base station, and a control method for the same.

The present invention further provides a method in which a terminal performs D2D communication at a cell boundary of a base station or out of coverage of a cell of a base station, and a control method for the same.

An exemplary embodiment of the present invention provides a Device-to-Device (D2D) communication method in which a first terminal within a first cell of a first base station directly communicates with a second terminal without relay of the first base station. The D2D communication method includes: receiving a synchronization signal and a synchronization channel that are broadcasted through a downlink by the first base station; acquiring synchronization for D2D communication using the synchronization signal and the synchronization channel; transmitting, when the first terminal is connected to the first base station, first information for D2D communication to the first base station through a first data channel for cellular communication in order to request allocation of a first resource for D2D communication; receiving D2D control information including information about the first resource that is allocated to the first terminal from the first base station; and broadcasting a second data channel for D2D communication using the D2D control information.

The first information may include: at least one of a first identifier of the first terminal and a second identifier of a first group to which the first terminal belongs; information about the first resource that the first terminal is to use; and information about a size of data that the first terminal is to transmit.

The transmitting of first information may include transmitting a Buffer Status Report (BSR) message including the first information to the first base station.

The D2D control information may include: at least one of the first identifier and the second identifier; at least one of a location of the first resource, a size of the first resource, and the number of the first resource; and at least one of a repetition cycle of the first resource and the repetition number of the first resource.

The receiving of D2D control information may include receiving the D2D control information from the first base station through at least one of a first control channel and a first response channel for a downlink.

The D2D communication method may further include transmitting the first information to the first base station through a third data channel after the first terminal is randomly accessed to the first base station through a random access channel, when a state of the first terminal is an idle state.

The receiving of D2D control information may further include: determining whether the D2D control information is information for the first terminal using the first identifier that is included in the D2D control information, when the first terminal is connected to the first base station; and determining whether the D2D control information is information for the first terminal using the second identifier that is included in the D2D control information, when a state of the first terminal is an idle state.

The broadcasting of a second data channel may include: broadcasting a first indicator channel including information on whether the first terminal transmits first data using the second data channel; broadcasting a second control channel for demodulating the first data; and broadcasting the second data channel in order to broadcast the first data.

The receiving of D2D control information may include: receiving, when the second terminal is located in coverage of a second cell of a second base station, the D2D control information further including second information about the difference between a synchronization time that the first base station uses and a synchronization time that the second base station uses from the first base station; and changing a synchronization time using the second information.

Another embodiment of the present invention provides a method in which a first terminal controls Device-to-Device (D2D) communication between terminals. The method may include: broadcasting a first synchronization signal and a first synchronization channel through an uplink, when the first terminal operates as a centralized control device that manages synchronization and a resource for D2D communication; receiving a first message that requests allocation of a first resource for D2D communication from a second terminal; and allocating the first resource to the second terminal.

The first synchronization channel may include information about a first identifier of the first terminal and a type of the first synchronization signal.

The first synchronization channel may further include at least one of information representing that the first synchronization channel is a channel for synchronization of D2D communication, information representing the first synchronization signal, information about accuracy of the first synchronization signal, information representing that the first terminal is a moving device, a moving speed of the first terminal, change information of a synchronization time for the first synchronization signal, location information of the first terminal, intensity of the first synchronization signal, and the number of terminals using the first synchronization signal.

The broadcasting of a first synchronization signal may include: receiving, when the second terminal does not receive a second synchronization signal that is broadcasted through a downlink by a base station, broadcasting instruction for the first synchronization signal from the base station; and operating as the centralized control device in response to the broadcasting instruction.

The broadcasting of a first synchronization signal may include: broadcasting, when receiving a second synchronization signal that is broadcasted through a downlink by a base station, the first synchronization signal based on the second synchronization signal; broadcasting, when receiving a Global Positioning System (GPS) signal instead of receiving the second synchronization signal, the first synchronization signal based on the GPS signal; broadcasting, when receiving a third synchronization signal that another centralized control device broadcasts instead of receiving the second synchronization signal and the GPS signal, the first synchronization signal based on the third synchronization signal; and broadcasting, when not receiving the second synchronization signal, the GPS signal, and the third synchronization signal, the first synchronization signal based on a randomly predetermined time.

The method may further include: transmitting, when receiving a second synchronization signal and a second synchronization channel that another centralized control device broadcasts, information about the second synchronization signal and the second synchronization channel to a base station; and stopping broadcasting the first synchronization signal, when receiving a broadcasting stop instruction from the base station.

The broadcasting of a first synchronization signal may include: receiving a second message representing that the second terminal, having received the first synchronization signal and the first synchronization channel, accesses to the first terminal, from the second terminal; and counting the number of terminals using the first synchronization signal based on the second message.

The method may further include: changing, when receiving a second synchronization signal that is broadcasted through a downlink by a base station, a synchronization time for the first synchronization signal based on the second synchronization signal; and reporting information about the first terminal operating as the centralized control device to the base station so that the base station determines whether the first terminal is to continue to operate as the centralized control device.

Yet another embodiment of the present invention provides a Device-to-Device (D2D) communication method in which a first terminal directly communicates with a second terminal without relay of a first base station. The D2D communication method may include: receiving a first synchronization signal and a first synchronization channel from a third terminal operating as a centralized control device that manages synchronization and a resource for D2D communication, when the first terminal is located out of coverage of a first cell of the first base station; transmitting a Buffer Status Report (BSR) message to the third terminal through a request channel for requesting resource allocation, when receiving the first synchronization signal and the first synchronization channel; receiving information about a first resource that is allocated to the first terminal from the third terminal through a response channel; and broadcasting a first indicator channel including information on whether the first terminal transmits first data using the first resource.

The D2D communication method may further include determining that the first terminal is located out of coverage of the first cell, when receiving intensity of a second synchronization signal that is broadcasted through a downlink by the first base station is a first threshold value or less or when a Radio Link Failure (RLF) occurs between the first terminal and the first base station.

The receiving of a first synchronization signal may include calculating the difference between a synchronization time for the first synchronization signal and a synchronization time for the second synchronization signal.

The transmitting of a BSR message may include transmitting the request channel including information about the synchronization time difference to the third terminal.

The D2D communication method may further include: determining that the first terminal is located in coverage of the first cell, when receiving intensity of the second synchronization signal is larger than the first threshold value; calculating the difference between a synchronization time for the first synchronization signal and a synchronization time for the second synchronization signal and transmitting the difference to the third terminal, when the first terminal is located in coverage of the first cell; and changing a synchronization time using the second synchronization signal.

### BRIEF DESCRIPTION OF THE DRAWINGS

FIG. 1 is a diagram illustrating a communication environment of D2D communication.

FIG. 2 is a graph illustrating a concept of an uplink channel used for D2D communication.

FIG. 3 is a flowchart illustrating a process in which a terminal that is located in coverage of a cell transmits data.

FIG. 4 is a diagram illustrating a kind of a channel used for D2D communication.

FIG. 5 is a flowchart illustrating a process in which a terminal that is located out of coverage of a cell transmits data.

FIG. 6 is a flowchart illustrating a process of transmitting/receiving data when a terminal having performed D2D communication in coverage of a cell moves out of coverage of a cell.

FIG. 7 is a flowchart illustrating a process of transmitting/receiving data when a terminal having performed D2D communication out of coverage of a cell moves into coverage of the cell.

FIG. 8 is a block diagram illustrating a configuration of a terminal.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a terminal may indicate a mobile terminal (MT), a mobile station (MS), an advanced mobile station (AMS), a high reliability mobile station (HR-MS), a subscriber station (SS), a portable subscriber station (PSS), an access terminal (AT), and user equipment (UE), and may include an entire function or a partial function of the MT, the MS, the AMS, the HR-MS, the SS, the PSS, the AT, and the UE.

Further, a base station (BS) may indicate an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) that performs a function of the BS, an HR-RS that performs a function of the BS, and a small BS, and may include an entire function or a partial function of the BS, the ABS, the HR-BS, the nodeB, the eNodeB, the AP, the RAS, the BTS, the MMR-BS, the RS, the HR-RS, and the small BS.

### 1. Resource and Synchronization for D2D Communication

### 1-1. Radio Resource Structure

In direct communication between terminals, i.e., D2D communication, in order to reduce complexity of a terminal, a frequency of an uplink band among frequency bands used in mobile communication is used. Specifically, a terminal transmits a signal for D2D communication through an uplink and receives a signal that another terminal transmits. A resource of the uplink band may be divided into a resource for cellular communication (e.g., communication between a base station and a terminal) and a resource for D2D communication (direct communication between terminals). Specifically, the resource for D2D communication may be subdivided into a base station control resource and a non-control resource. The base station control resource is a resource that a base station allocates to a terminal that is located in coverage of a cell. The base station may designate location and range information of the base station control resource to a predetermined value and broadcast the value through a cell control channel. Alternatively, the terminal may receive location and range information of the base station control resource from a D2D communication server. The non-control resource is a resource that a terminal that is not accessed to the base station uses, and the centralized control device may allocate a non-control resource to the terminal. The centralized control device may be a terminal or a device other than a terminal.

The base station may allocate a synchronization signal transmitting area necessary for synchronization of the terminal. The base station may use some resources of an uplink band for a synchronization signal, and the synchronization signal resource may be a non-control resource.

The base station may perform management and transmission/reception of a base station control resource. Further, the base station may perform management and transmission/reception of a non-control resource.

Hereinafter, for better comprehension and ease of description, a case in which a channel used for D2D communication is divided into a frequency unit and a time unit (e.g., a subframe) will be exemplified.

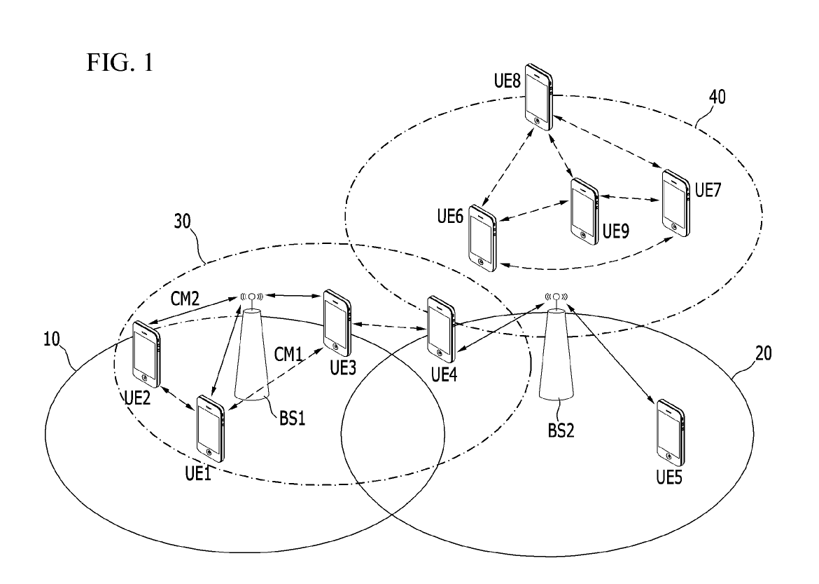

FIG. 1 is a diagram illustrating a communication environment of D2D communication.

UE1-UE3 that are located in coverage of a cell 10 of a BS1 may perform mobile communication or cellular communication CM2 through relay of the BS1. Further, the UE1-UE3 that are located in coverage of the cell 10 of the BS1 may perform D2D communication CM1 according to the control of the BS1.

The UE3 that is located in coverage of the cell 10 may perform D2D communication CM1 with a UE4 that is located in coverage of a cell 20 of a neighboring base station BS2 in a state in which time offset is managed. Specifically, the UE3 may perform D2D communication CM1 with the UE1, UE2, and UE4 that are located within a D2D communication range 30 thereof.

UE6-UE9 that are located out of coverage of the cells 10 and 20 of the BS1 and BS2 may perform D2D communication CM1 according to the control of a centralized control device UE9. Specifically, the UE9 may perform D2D communication CM1 with the UE6-UE8 that are located within a D2D communication range 40 thereof. When the UE9 has a function of a centralized control device, the UE9 may operate as a centralized control device. Here, a function of a centralized control device includes a function of managing and allocating a radio resource necessary for D2D communication and a function of managing synchronization for D2D communication.

### 1-2. Time Synchronization at Cell Boundary

In order for a terminal to participate in D2D communication, the terminal should maintain time synchronization of a predetermined level. For example, a terminal (e.g., UE1) that is located in coverage of the cell 10 may use a synchronization signal that the BS1 broadcasts through a downlink, or may maintain synchronization of a downlink using a control signal transmitting together with a data channel.

For D2D communication, a time synchronization procedure using a synchronization signal that is transmitted through an uplink is required. For example, a terminal (e.g., UE3) that is located at the boundary of the cell 10 or a terminal (e.g., UE6) that is located out of coverage of the cells 10 and 20 requires an additional synchronization procedure. A signal for time synchronization of an uplink may be broadcasted by a general terminal or a centralized control device that manages synchronization of D2D communication.

The BS1 may receive a synchronization signal that a terminal or a centralized control device broadcasts using a resource of an uplink band and change a broadcasting reference value of the received synchronization signal. Further, the BS1 may instruct a centralized control device to transmit a synchronization signal or to stop transmission of a synchronization signal. A terminal having a function of controlling D2D communication may perform a function of a centralized control device. A terminal operating as a centralized control device may be located in coverage of the cells 10 and 20, at the boundary of the cells 10 and 20, or out of coverage of the cells 10 and 20.

A process in which a terminal (e.g., UE3) that is located at the boundary of the cells 10 and 20 maintains time synchronization is as follows. The UE3 periodically receives a downlink synchronization signal that the BS1 broadcasts. When the UE3 does not acquire a synchronization signal, the UE3 searches for an uplink physical channel in which a centralized control device broadcasts. The centralized control device searches for a synchronization signal that another centralized control device broadcasts, and when the centralized control device does not receive a synchronization signal of an uplink, the centralized control device directly broadcasts a synchronization signal of an uplink. When the centralized control device transmits a synchronization signal, the centralized control device may report information thereof and information of the synchronization signal to the base station (e.g., BS1), or may request allowance of transmission of a synchronization signal.

A physical channel used for synchronization of a terminal may be divided into a synchronization signal and a synchronization channel. Specifically, the synchronization signal (e.g., a Primary Synchronization Signal (PSS) or a Secondary Synchronization Signal (SSS)) physically includes information for synchronization acquisition of a terminal. In order to distinguish a synchronization signal that another centralized control device transmits, the centralized control device may broadcast a synchronization signal and a synchronization channel using a Frequency Division Multiplexing (FDM) method or a Code Division Multiplexing (CDM) method. A time location of a synchronization signal may be fixed, and may be allocated with a predetermined cycle in an uplink band. Because the synchronization signal includes only information necessary when a terminal acquires synchronization, additional information may be broadcasted through a synchronization channel. Specifically, the synchronization channel may include at least one of synchronization channel indication information, time information, synchronization signal information, standalone information, relay information, accuracy, physical cell ID, centralized control device ID, mobility information, time change information, location information, signal intensity information, and terminal connection information, as shown in Table 1. In order to be quickly acquired by a terminal, a portion of information of Table 1 may be included in a synchronization signal instead of a synchronization channel.

TABLE 1

| Information | Remarks |
|---|---|
| Synchronization channel indication | Information representing (indicating) a synchronization |
| information | channel |
| | In order to enable another terminal to distinguish, a |
| | synchronization channel including synchronization |
| | channel indication information may be broadcasted. |
| Time information | Time information such as System Frame Number |
| | (SFN) information |
| Synchronization signal information | Information about a synchronization signal mapped to |
| | a synchronization channel |
| Standalone information | Information representing a synchronization channel |
| | broadcasted without synchronization of a base station |
| | (e.g., synchronization acquisition using a GPS) |
| Relay information | Information representing a synchronization channel |
| | broadcasted based on synchronization of a base |
| | station |
| | In a synchronization channel broadcasted based on |
| | synchronization of a base station, type information |
| | representing uplink synchronization or downlink |
| | synchronization |
| | Indicate with a different method in a device |
| | broadcasting by relaying synchronization of a |
| | peripheral centralized control device |
| Accuracy | Accuracy of a synchronization signal (e.g., an error |
| | range or a hop count when synchronization of a base |
| | station is relayed) |
| Physical cell ID | A cell identifier of a base station using as a reference |
| | value |
| Centralized control device ID | Identifier of a device broadcasting a synchronization |
| | signal |
| Mobility information | Information representing that a centralized control |
| | device is a moving device or a moving speed of a |
| | centralized control device (e.g., a high speed, a low |
| | speed, and a fixed speed) |
| Time change information | Change information of a reference synchronization |
| | time of a synchronization signal that a device transmits |
| | (e.g., offset between a synchronization time thereof |
| | and a change synchronization time, a time to which a |
| | time change is applied (a time to execute a time |
| | change) |
| Location information | Location information of a centralized control device |
| Signal intensity information | Signal intensity of a centralized control device |
| Terminal connection information | Information representing that a terminal or another |
| | centralized control device using a synchronization |
| | signal of a centralized control device exists (e.g., the |
| | number of terminals using a synchronization signal of |
| | a centralized control device) |
| Type of Synchronization Source | Represent a characteristic of a device (e.g., eNodeB, |
| | UE, broadcasting UE, CH, etc.) |

By including and broadcasting cell system information that a Long Term Evolution (LTE) base station (e.g., BS1) broadcasts in a synchronization channel in addition to information of Table 1, the centralized control device may broadcast a communication parameter necessary for D2D communication. Here, a communication parameter necessary for D2D communication may include channel information (e.g., time/frequency information, magnitude, cycle, transmission power) used for D2D communication and available information of a D2D communication channel.

In order to periodically transmit a synchronization channel and to avoid a collision with another channel, by periodically changing a location of the synchronization channel, the centralized control device may transmit the synchronization channel. Specifically, by changing a transmitting location of the synchronization channel using a Time Division Multiplexing (TDM) method and transmitting a synchronization channel, the centralized control device enables another centralized control device that transmits a synchronization channel at the same location to avoid a collision. When the centralized control device transmits a synchronization channel, by receiving a synchronization channel broadcasting area in which the centralized control device does not transmit with a predetermined cycle, the centralized control device determines whether another centralized control device transmits a synchronization channel. When the centralized control device determines that another centralized control device transmits a synchronization channel, in order to avoid a collision of a synchronization signal, the centralized control device may stop transmission of the synchronization signal or the synchronization channel or may request transmission stop of another centralized control device.

The centralized control device may broadcast control information similar to system information that a base station (e.g., BS1) broadcasts through a synchronization channel. Specifically, the centralized control device may transmit information of a synchronization channel using the same procedure and channel structure as those of a data channel.

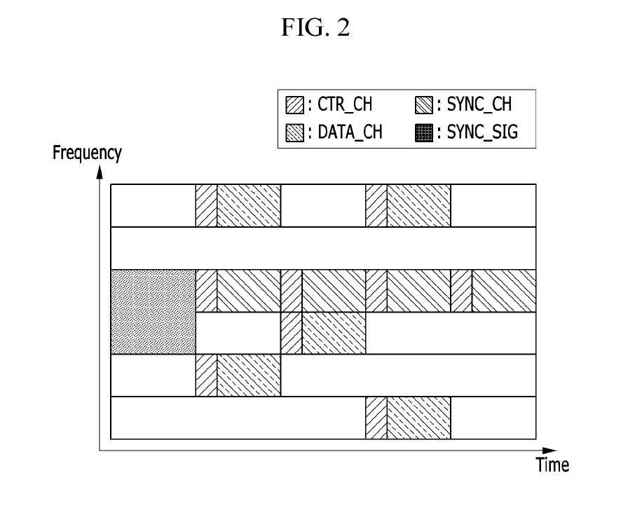

FIG. 2 is a graph illustrating a concept of an uplink channel using for D2D communication.

For convenience of description, FIG. 2 illustrates a synchronization signal SYNC_SIG, a synchronization channel SYNC_CH, a control channel CTR_CH, and a data channel DATA_CH that are transmitted through an uplink.

When a centralized control device broadcasts a synchronization signal with an uplink, the centralized control device may transmit a synchronization signal in the following condition. Specifically, when the centralized control device acquires a synchronization signal of a base station (e.g., BS1), the centralized control device broadcasts a synchronization signal with reference to the acquired synchronization signal. When the centralized control device does not acquire a synchronization signal of a base station (e.g., BS1), the centralized control device acquires a synchronization reference value (e.g., a GPS signal) and broadcasts a synchronization signal. For example, the centralized control device may acquire a signal such as a Global Positioning System (GPS) signal or acquire synchronization information from a wired network and broadcast a synchronization signal with reference to the acquired signal or information. When the centralized control device acquires a synchronization signal that another centralized control device transmits, the centralized control device may transmit a synchronization signal with reference to the acquired synchronization signal. When the centralized control device does not acquire a synchronization reference (e.g., a synchronization signal of a base station, a GPS signal, and a synchronization signal of another centralized control device), the centralized control device may randomly designate a synchronization reference (time) and transmit a synchronization signal.

The base station (e.g., BS1) may determine necessity of a centralized control device and instruct a peripheral terminal to broadcast a synchronization signal as a centralized control device. Specifically, when the terminal is located at the cell boundary or deviates from the range of the cell, the BS1 may instruct a peripheral terminal to operate as a centralized control device. For example, when the BS1 recognizes that a signal of the UE3 moving at the boundary of the cell 10 becomes poor, the BS1 may instruct a peripheral terminal to broadcast a synchronization signal as a centralized control device. Further, when a neighboring cell is not constructed at a periphery, the BS1 may instruct a peripheral terminal to operate as a centralized control device. For example, when the UE3 is located in an area in which a cell is not disposed according to a base station construction structure, the BS1 may instruct a peripheral terminal to broadcast a synchronization signal as a centralized control device. Further, when the terminal requests a centralized control device from the base station, the BS1 may instruct a peripheral terminal to operate as a centralized control device. For example, when the UE3 notifies the BS1 that a synchronization signal is necessary, the BS1 may instruct to broadcast a synchronization signal as a centralized control device to a peripheral terminal.

Transmission/reception of a message for distribution synchronization is required, and a procedure thereof is as follows. Specifically, the base station (e.g., BS1) sends a request to a peripheral terminal to determine whether the peripheral terminal may operate as a centralized control device. For example, the BS1 may transmit a request message through a paging channel, a broadcasting channel, or a data channel. The terminal having received the request message responds about whether the terminal may operate as a centralized control device. For example, the terminal may include (indicate) and transmit mobility, signal intensity, power source state, and location information thereof in a response message. A terminal having insufficient conditions does not respond. The BS1 having received the response message instructs the terminal having transmitted the response message to operate as a centralized control device. For example, the BS1 may determine a condition, select at least one of the terminals having transmitted the response message, and transmit an instruction message to the at least one terminal. The terminal having received the instruction message performs a function of a centralized control device. The terminal may transmit a response message to the instruction message.

When many terminals (centralized control devices) transmit a synchronization signal, a collision may occur, and thus a procedure in which some terminals stop transmission of a synchronization signal is required. However, when transmission of a synchronization signal that another terminal uses is stopped, a problem may occur and thus a procedure that avoids this is required. Specifically, when a terminal operates as a centralized control device, a procedure that releases broadcasting of an overlapping synchronization signal is as follows. When the centralized control device starts broadcasting of a synchronization signal, the centralized control device receives a synchronization signal that a peripheral centralized control device broadcasts. When the centralized control device detects a synchronization signal of another centralized control device, the centralized control device receives a synchronization channel of the other centralized control device. The centralized control device reports receiving of information (synchronization signal, synchronization channel) to the base station (e.g., the BS1). The BS1 detects whether an overlapping synchronization signal is broadcasted using the reported information. When broadcasting of an overlapping synchronization signal is detected, the BS1 instructs to stop broadcasting of a synchronization signal to at least one of centralized control devices that broadcast the overlapping synchronization signal. The terminal having received the synchronization signal broadcasting stop instruction stops broadcasting of the synchronization signal and responds to stop completion. The terminal operating as a centralized control device may directly stop operation of the centralized control device without the control of the base station (e.g., BS1).

A synchronization acquisition method of a general terminal that does not operate as a centralized control device is as follows. Specifically, when a peripheral centralized control device broadcasts a synchronization signal with an uplink, the general terminal may receive an uplink synchronization signal. The general terminal having received the uplink synchronization signal may transmit an access confirmation message to the centralized control device. For example, after a general terminal completes reception of a synchronization channel, the general terminal may transmit an access confirmation message to the centralized control device. When the centralized control device does not receive an access confirmation message, the centralized control device may randomly stop broadcasting of a synchronization signal. When the centralized control device receives an access confirmation message, the centralized control device may reserve stop of the synchronization signal broadcasting. In order to manage the number of terminals having accessed to the centralized control device, the centralized control device may use a count procedure or a channel. For example, when a general terminal transmits an access confirmation message to the centralized control device using an uplink channel, the centralized control device may count the access confirmation message and determine whether the terminal is accessed or the number of access terminals. The centralized control device may determine that an access confirmation message is received and respond to a terminal having transmitted the access confirmation message. For example, the centralized control device may include and broadcast access information in a synchronization channel. When the general terminal releases access, the general terminal may report release to the centralized control device. For example, the general terminal may include (indicate) and transmit an access release request in the access confirmation message. The centralized control device having received the release request instructs access release to the terminal that requests access release. For example, the centralized control device may include (indicate) stop of broadcasting of a synchronization signal in a synchronization channel and broadcast the synchronization channel. The terminal having received an instruction of access release may determine access release and respond to the centralized control device.

### 1-3. Time Synchronization Out of Coverage of Cell

A synchronization procedure of the UE6-UE9 that are not located in coverage of the cells 10 and 20 of the BS1 and the BS2 will now be described.

General UE6-UE8 that do not have a function of the centralized control device continuously perform an operation that receives an uplink synchronization signal (a synchronization signal that a centralized control device (UE9) broadcasts through an uplink) or a downlink synchronization signal (a synchronization signal that the BS1 and the BS2 broadcast through a downlink). Before acquiring synchronization, general UE6-UE8 do not broadcast a signal. When general UE6-UE8 transmit a signal in an asynchronous state, it is difficult to acquire synchronization and this may disturb other communication.

When the UE9 having a function of a centralized control device does not have synchronization, a procedure that acquires synchronization is as follows. Specifically, the UE9 receives synchronization information (e.g., GPS signal) that may refer in addition to a synchronization signal of the BS1 and the BS2. When the UE9 receives synchronization information that may refer, after a predetermined time has elapsed, the UE9 broadcasts a synchronization signal and a synchronization channel. For example, the UE9 may use a timer, and a timer value (cycle) may be differently designated according to capability of the UE9. That is, when a priority of the UE9 is high, the UE9 may quickly transmit a synchronization signal and a synchronization channel. The UE9 that transmits a synchronization channel receives a synchronization signal and a synchronization channel of another terminal (centralized control device). For example, when the UE9 transmits a synchronization signal and a synchronization channel, the UE9 may not receive a signal, and thus only at another time (a time when a synchronization signal and a synchronization channel are not broadcasted) may the UE9 perform an operation of receiving a synchronization signal and a synchronization channel of another centralized control device. The UE9 receives a synchronization channel of another centralized control device and determines information. When the UE9 determines that another centralized control device transmits a synchronization signal and a synchronization channel, the UE9 may stop transmission of a synchronization signal thereof. For example, when a priority of the UE9 is lower than that of another centralized control device, the UE9 may stop broadcasting of a synchronization signal. When the UE9 stops transmission of a synchronization signal, the UE9 may indicate (include) stop information of transmission of a synchronization signal and a synchronization channel in the synchronization channel.

A case in which the centralized control device UE9 that broadcasts a synchronization signal and a synchronization channel out of coverage of the cells 10 and 20 moves into the cell 20 will now be described.

The UE9 operating as a centralized control device searches for a downlink synchronization signal out of coverage of the cells 10 and 20. When the UE9 acquires a downlink synchronization signal of the BS2, the UE9 determines that the UE9 is located in coverage of the cell 20, and the UE9 may change a synchronization signal thereof based on a synchronization time of a received downlink synchronization signal. The UE9 may indicate (include) synchronization time change information in a synchronization signal and a synchronization channel thereof. The UE9, having acquired the downlink synchronization signal of the BS2, may access the BS2 and report information of the UE9 operating as a centralized control device. The BS2 may stop the UE9 from operating as a centralized control device with reference to information that the UE9 reports.

### 1-4. Time Synchronization Between Cells

When the cells 10 and 20 that the BS1 and the BS2 construct use different time synchronization, D2D communication may become complex. Therefore, by performing a procedure that maintains synchronization between the cells 10 and 20, a network may maintain time synchronization between the cells 10 and 20.

When time synchronization between the cells 10 and 20 is not maintained, the BS1 and the BS2 or the UE3 and the UE4 may measure or calculate a synchronization time difference between the cells 10 and 20. The UE3 and the UE4 may perform D2D communication using the calculated synchronization time difference information.

Specifically, as the UE3 is located in coverage of the cell 10 of the BS1, the UE3 receives a downlink synchronization signal in which the BS1 performs D2D communication according to the centralized control of the BS1.

When terminal group information that is set to the UE3 is not included in control information (e.g., system information, or control information that the BS1 instructs) of the BS1, the UE3 may transmit terminal group information that the UE3 stores to the BS1 and request D2D communication.

By requesting to another superordinate node using a network procedure, the BS1 collects time synchronization information and terminal group information that the peripheral cell 20 manages. The BS1 may determine whether the UE3 supports D2D communication based on the collected information and transmit the determined D2D control information to the terminal through a broadcasting channel or a data channel. D2D control information may include offset between time synchronization information of the neighboring cell 20 and time synchronization information presently used in the cell 10. Further, D2D control information may further include D2D control information of the neighboring cell 20.

The UE3 receives an uplink channel based on D2D control information that is received from the BS1 and performs D2D communication. Specifically, the UE3 may change a synchronization time thereof according to a synchronization time offset between the cells 10 and 20, receive an indicator channel, a control channel, and a data channel, and perform D2D communication with the UE4 within the neighboring cell 20.

### 2. D2D Communication in Coverage of Cell

In D2D communication, a physical layer structure of a multicast method or broadcast in which a transmitting terminal transmits data and in which all peripheral terminals directly receive data is used. In such a physical layer structure, in order to support a function in which only some terminals can participate in D2D communication, a method of dividing a terminal into a group and in which terminals that are included in a corresponding group perform D2D communication is appropriate. For this reason, an uplink band is divided into a group resource (e.g., an uplink band is divided into a frequency axis and a predetermined bandwidth is allocated to a terminal group), and the group resource is used for D2D communication.

A group resource in coverage of the cells 10 and 20 is allocated to the terminal at a generation time point of a terminal group, and the BS1 and the BS2 may transmit the group resource to the terminal using a Radio Resource Control (RRC) message. A terminal that belongs to a group may receive a group resource, and a terminal that belongs to a plurality of groups may receive a plurality of group resources.

A terminal transmitting resource is a resource that the BS1 and the BS2 allocate when a terminal requests transmission. The BS1 and the BS2 may allocate some of group resources as a terminal transmitting resource. By transmitting a control message through a downlink channel, the BS1 and the BS2 may allocate a resource to the terminal and periodically allocate a resource or continuously allocate several subframes. When there is no problem in power consumption of the terminal, the terminal may always receive a control channel and a data channel of an entire band. A group identifier for identifying a terminal group is allocated when the BS1 and the BS2 transmit a message, and the terminal may use a group identifier for modulation/demodulation of a data channel or a control channel. The base station may have a function of a centralized control device, and in this case, the base station may transmit/receive a control signal and a control channel using an uplink bandwidth.

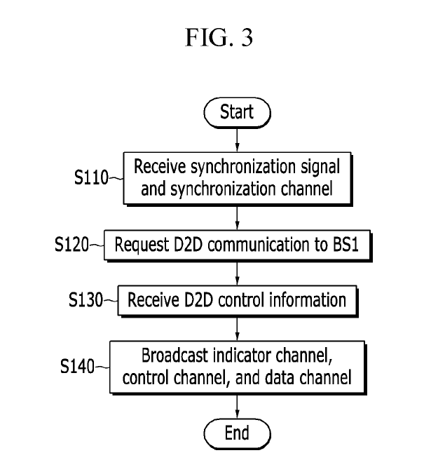

FIG. 3 is a flowchart illustrating a process in which the UE1 that is located in coverage of the cell 10 transmits data.

The UE1 receives a synchronization channel and a system information channel that the BS1 transmits (S110). Specifically, the UE1 receives D2D communication information through a synchronization channel and a system information channel. For example, the UE1 may receive location information of a resource for D2D communication and resource information related to a terminal group.

The UE1 requests D2D communication to the BS1 (S120). Specifically, when a state of the UE1 is a connected state in which the UE1 is connected to the BS1, a method of use in cellular communication may be extended and applied. For example, the UE1 may transmit a message (e.g., a Scheduling Request (SR) message or a Buffer Status Report (BSR) message) that requests allocation of a resource for D2D communication to the BS1. The UE1 may use an SR message used in cellular communication and transmit D2D communication related information to the BS1 through a data channel. The UE1 may transmit D2D communication related information to the BS1 using a data channel used in cellular communication. That is, the UE1 may indicate D2D communication related information in a data channel (e.g., a Physical Uplink Shared Channel (PUSCH)) used for cellular communication with the BS1 and transmit the D2D communication related information to the BS1.

When a state of the UE1 is an idle state in which the UE1 is not connected to the BS1, the UE1 requests D2D communication to the BS1 using a random access procedure (S120). Specifically, the UE1 is randomly accessed to the BS1 through a Random Access Channel (RACH) using a random access procedure used in cellular communication, requests D2D communication to the BS1, and transmits D2D communication related information to the BS1. Even when a state of the UE1 is a connected state, a random access procedure may be used. Among radio resources used as a RACH, a predetermined resource may be divided and used for a random access procedure for a D2D communication request. That is, the BS1 may allocate a radio resource of a predetermined magnitude for a D2D communication request or designate a portion of random access codes for a D2D communication request. The BS1 may recognize information that is received through a resource that is designated for a D2D communication request as information for D2D communication. After a random access procedure, the UE1 may transmit additional D2D communication related information to the BS1. For example, the UE1 may transmit D2D communication related information to the BS1 using an uplink data channel. Here, D2D communication related information may include at least one of information of Table 2.

TABLE 2

| Information | Remarks |
|---|---|
| Terminal group | D2D communication group identifier that a transmitting |
| information | terminal is to use |
| | Resource information that a transmitting terminal |
| | is to use Authentication information of a transmitting |
| | terminal (information representing that a transmitting |
| | terminal is a terminal that is allowed to use D2D |
| | communication) |
| Terminal | Identifier of a transmitting terminal |
| information | Location information of a transmitting terminal |
| | Transmission power information of a transmitting |
| | terminal |
| | Mobility information of a transmitting terminal |
| | Power source state of a transmitting terminal |
| Service | Priority |
| characteristic | Data rate |
| | Service kind, etc. |
| Cycle | One time transmission or periodic transmission |
| Buffer | Size of data to transmit |
| information | |

The BS1, having received a D2D communication request, transmits D2D control information to the UE1, and the UE1 receives D2D control information (S130). Specifically, the BS1 may transmit D2D control information using a downlink control channel or a response channel according to a form of the received D2D communication request. For example, the BS1 may indicate and transmit brief D2D control information in the downlink control channel (e.g., a Physical Downlink Control Channel (PDCCH)). Alternatively, the BS1 may transmit D2D control information using a response channel (e.g., a Random Access Response (RAR) or a Physical Downlink Shared Channel (PDSCH). The BS1 provides an identifying method so that the UE1 may receive a message including D2D control information. For example, when a state of the UE1 is a connected state, the BS1 may indicate and transmit an identifier (e.g., a Cell-Radio Network Temporary Identifier (C-RNTI)) of the UE1 in a channel. When a state of the UE1 is an idle state, the BS1 may indicate and transmit a plurality of pieces of D2D control information and a group identifier in one data channel (e.g., PDSCH). Here, D2D control information may include at least one of terminal group identification information, terminal identification information, location information of a resource, magnitude information of a resource, number information of a resource, transmission power information of a resource, a repetition cycle of an allocation resource, and a repetition number of an allocation resource.

The UE1 receives D2D control information that is transmitted by the BS1, and broadcasts an indicator channel, a control channel, and a data channel for D2D communication using allocated information (S140). Specifically, the UE1 determines whether D2D control information is information for the UE1 using terminal group identification information or terminal identification information that is included in D2D control information. The UE1 may generate a control channel and a data channel, and broadcast the control channel and the data channel to an allocated resource. The UE1 may indicate brief information necessary when a receiving terminal demodulates a data channel in an indicator channel. When the receiving terminal can demodulate a signal with only information that is included in an indicator channel, the UE1 may omit broadcasting of a control channel. Specifically, the indicator channel may include location information of the control channel or the data channel, and after the receiving terminal receives the indicator channel, the receiving terminal may know a location of the control channel or the data channel through location information that is included in the indicator channel.

The UE1 indicates and broadcasts whether data is transmitted in the indicator channel, and the receiving UE2 and the BS1 may receive an indicator channel that is broadcasted by the UE1 and determine whether a data resource is used. The BS1 may determine a resource in which transmission is not indicated through the received indicator channel, determine a resource in which transmission is not indicated as an unused resource, and allocate a resource that is determined as an unused resource to another terminal.

A procedure in which the UE2 that is located in coverage of the cell 10 receives data is as follows. Specifically, the UE2 acquires a synchronization signal of the BS1 and receives D2D control information through system information of the BS1. The UE2, having received D2D control information, receives an indicator channel that the UE1 transmits. When it is indicated in the received indicator channel that D2D communication data is being broadcasted, the UE2 receives and demodulates a control channel and a data channel of the indicated resource. When it is indicated in the received indicator channel that there is no broadcasting D2D communication data, the UE2 omits a demodulation operation of a control channel and a data channel corresponding to location information that is included in the indicator channel.

When a brief collision management procedure for D2D communication is used, a data resource may be overlappingly allocated to a plurality of terminals. A procedure for compensating this will be described.

The transmitting UE1 requests transmission of D2D communication data using a random access channel (RACH) to the BS1. When a plurality of UE1 and UE3 request data transmission at the same time or using the same identifier, a collision may occur.

The BS1 responds that a data transmission request has been received using a response channel. For example, when a small amount of data transmission is requested, the BS1 indicates and transmits a D2D communication resource that is allocated to a response channel, and a plurality of UE1 and UE3 perform D2D communication using an allocated resource. In this case, a collision may occur between the UE1 and UE3, but in order to reduce complexity, a collision solving procedure is not used.

The transmitting UE1 transmits detailed information for a D2D communication request to the BS1. When a plurality of UE1 and UE3 successfully receive a response channel that is transmitted by the BS1, the plurality of UE1 and UE3 transmit a message including detailed information for a D2D communication request to the BS1 and thus a collision may occur. As a plurality of messages collide, when demodulation is impossible, the BS1 may release a resource that is allocated to the UE1 and UE3. As only a message of the UE1 is received, when the BS1 can demodulate a message, the BS1 transmits a response message to the UE1.

The BS1 allocates a D2D communication resource and transmits the D2D communication resource to the UE1. Specifically, the BS1 may include and transmit D2D communication resource information in D2D control information.

When terminal identification information (terminal identification information that is included in received D2D control information) that is indicated in a resource represents the UE1, the UE1 performs D2D communication using the received D2D communication resource. When terminal identification information that is included in the received D2D control information does not represent the UE3, it is determined that the UE3 has been failed in resource allocation. The UE3, having failed in resource allocation restarts a resource allocation procedure.

The UE1 may perform D2D communication through a D2D communication procedure out of coverage of a cell to be described later even in coverage of the cell 10, and in this case, the BS1 may perform a function of a centralized control device.

### 3. D2D Communication Out of Coverage of Cell

D2D communication out of coverage of the cells 10 and 20 in which the control of the BS1 and the BS2 is impossible is controlled by a centralized control device.

An essential function necessary for D2D communication may be performed when time synchronization between terminals is maintained, and the centralized control device provides a synchronization signal for D2D communication. Further, the centralized control device broadcasts a synchronization signal and a synchronization channel, and a peripheral terminal, having received the broadcasted synchronization signal and synchronization channel, uses time synchronization. The centralized control device performs a radio resource management and allocation function necessary for D2D communication, and a peripheral terminal transmits/receives data according to the control of the centralized control device.

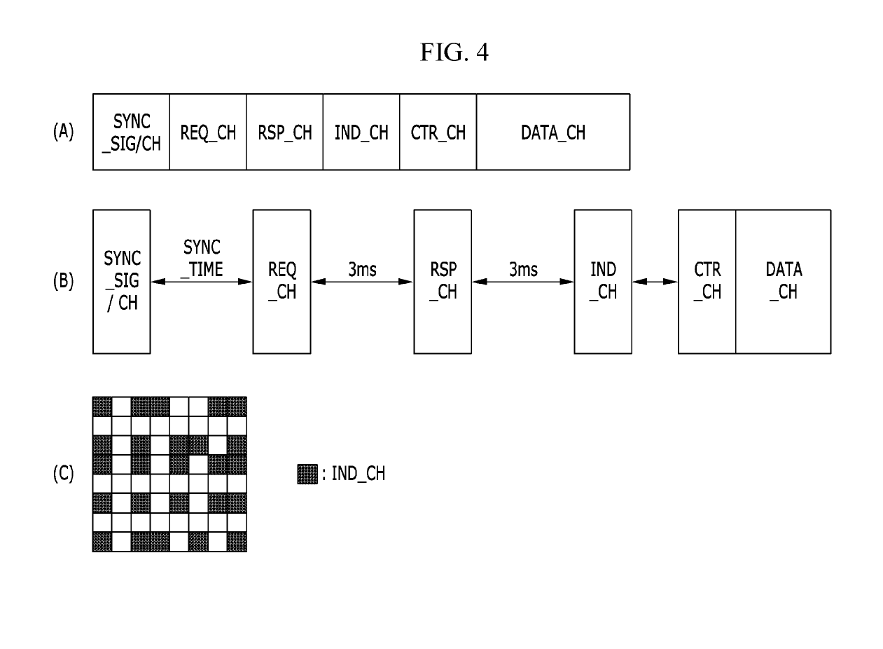

FIG. 4 is a diagram illustrating a kind of a channel using for D2D communication.

As shown in (A) of FIG. 4, a synchronization signal/channel SYNC_SIG/CH, a request channel REQ_CH, a response channel RSP_CH, an indicator channel IND_CH, a control channel CTR_CH, and a data channel DATA_CH are used for D2D communication. As shown in (B) of FIG. 4, a synchronization time SYNC_TIME exists between the synchronization signal/channel SYNC_SIG/CH and the request channel REQ_CH, a time gap of 3 ms exists between the request channel REQ_CH and the response channel RSP_CH, a time gap of 3 ms exists between the response channel RSP_CH and the indicator channel IND_CH, and a time gap exists between the indicator channel IND_CH and the control channel CTR_CH. (C) of FIG. 4 illustrates the indicator channel IND_CH. When each of signals and channels SYNC_SIG, REQ_CH, RSP_CH, IND_CH, CTR_CH, and DATA_CH is mapped to a physical resource, each of signals and channels SYNC_SIG, REQ_CH, RSP_CH, IND_CH, CTR_CH, and DATA_CH may be mapped in a form different from (A), (B), and (C) of FIG. 4, and a time gap between channels may be changed.

A frame structure that is used in a centralized control method is shown in Table 3.

TABLE 3

| Signal or Channel | Remark |
|---|---|
| Synchronization | 1) A synchronization signal transmitted with an uplink band |
| signal/channel | 2) A synchronization signal: broadcast only a signal such as |
| (SYNC_SIG/CH) | PSS/SSS, a cell identifier, etc. |
| | 3) A synchronization channel: detailed environment information |
| | related to D2D communication |
| | 3-1) A fixed location: a method similar to System Information Block |
| | (SIB )1 of a cellular communication method |
| | 3-2) Broadcast detailed control information with a broadcast #0 |
| | data channel |
| | 3-3) Method of distinguishing a characteristic of a synchronization |
| | channel and of distinguishing synchronization channels, when |
| | receiving a plurality of synchronization channels |
| Data channel | 1) Channel for broadcasting data |
| (DATA_CH) | 2) Use Cyclical Redundancy Check (CRC) |
| | 3) Can be transmitted using a terminal identifier or a group |
| | identifier |
| Control channel | 1) Channel for broadcasting data modulation/demodulation |
| (CTR_CH) | information |
| | 2) A transmitting terminal transmits |
| | 3) Use PDCCH form (many portions may be omitted) |
| Indicator channel | 1) Indicate data channel DATA_CH use information |
| (IND_CH) | 1-1) Include information representing whether a transmitting |
| | terminal transmits data using an allocated data channel or |
| | resource |
| | 1-2) Include resource location information of a control channel or a |
| | data channel |
| | 2) A receiving terminal monitors and uses for demodulation |
| | 3) Indicate brief demodulation information or only mid-term |
| | demodulation information |
| | 4) Object for reducing power consumption of a receiving terminal |
| | 5) A transmitting terminal broadcasts |
| | 6) When a transmitting terminal stops transmission of a data |
| | channel, the transmitting terminal releases transmission of an |
| | indicator channel corresponding to the stopped data channel. |
| | 7) A centralized control device determines a released channel by |
| | continuing to receive an indicator channel. |
| Request channel | 1) A channel in which a transmitting terminal requests resource |
| (REQ_CH) | allocation |
| | 2) One-to-one communication: a transmitting terminal transmits to |
| | a centralized control device |
| | 3) Based on collision |
| | 4) Distinguished into a plurality of TDMs |
| | 5) Additional information is required: BSR, type information (e.g., |
| | one shot, periodic, Quality of Service (QoS)), etc. |
| Response channel | 1) The centralized control device indicates |
| (RSP_CH) | modulation/demodulation information |
| | 2) One-to-one communication: the centralized control device |
| | responds to the transmitting terminal |
| | 3) The centralized control device transmits: mapped with |
| | one-to-one to a request channel REQ_CH and is formed in a |
| | PDCCH form |
| | 4) A response channel RSP_CH of a request channel REQ_CH: |
| | locate at a point separated by a predetermined time (e.g., 4 ms) or |
| | more from a request channel REQ_CH |
| | 5) Indicate resource information of a data channel DATA_CH |
| | 5-1) A Location, a length, and a cycle of a resource |

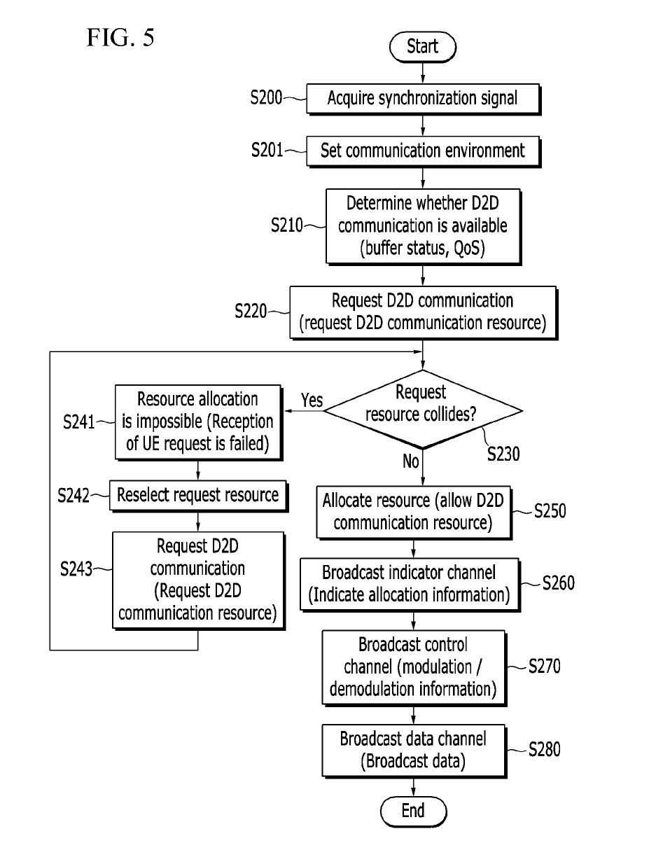

FIG. 5 is a flowchart illustrating a process in which the UE 6 that is located out of coverage of the cells 10 and 20 transmits data.

The UE6 acquires a synchronization signal (S200). Specifically, the UE6 may receive a synchronization signal that the UE9 operating as a centralized control device broadcasts through an uplink. Alternatively, the UE6 may receive a synchronization signal that a simple synchronization device broadcasts.

The UE6 receives synchronization information and terminal coverage communication information, and sets a communication environment (S201). Specifically, the UE6 may receive information similar to SIB of the BS1 and the BS2. The UE6 may receive location, cycle, and fixed value information of a D2D communication resource. The UE6 may receive information about a frame format.

The UE6 determines whether D2D communication is available (S210). Specifically, when data is input to a D2D transmitting buffer, the UE6 may determine the D2D communication start using an amount of data and a kind (QoS) of data. For example, when data is input to an empty D2D transmitting buffer, the UE6 may immediately start D2D communication. For another example, when an additional data is input to a D2D transmitting buffer in which data has existed, if the input additional data is information having high QoS, the UE6 may restart D2D communication.

In order to request D2D communication, the UE6 transmits a request channel RSQ_CH to the UE9 operating as a centralized control device (S220). Specifically, the UE6 may request a resource for D2D communication to the UE9 using a one-to-one communication method (e.g., a Physical Uplink Control Channel (PUCCH)). In order to request resource allocation, the UE6 may transmit a BSR message to the UE9 through a request channel RSQ_CH.

The UE9 determines whether a resource that the UE6 requests collides with a resource that other UE7 and UE8 request (S230), and if a resource that the UE6 requests collides with a resource that other UE7 and UE8 request, the UE9 determines that it is impossible to allocate a resource that the UE6 requests (S241). If a resource that the UE6 requests collides with a resource that other UE7 and UE8 request, the UE9 cannot analyze a resource request and thus does not allocate a D2D communication resource to the UE6. That is, if a resource that the UE6 requests collides with a resource that other UE7 and UE8 request at step S230, the UE6 does not receive allocation of a request resource.

If a resource that the UE6 requests collides with a resource that other UE7 and UE8 request at step S230, the UE6 reselects a request resource (S242), and in order to request D2D communication, the UE6 retransmits a request channel RSQ_CH to the UE9 (S243). Specifically, in order to avoid a collision, the UE6 may distribute a resource using a hashing method. For example, the UE6 may randomly select at least one of the N number (N is a natural number) of resources for D2D communication and request allocation of the selected resource to the UE9. When resource collisions of the predetermined number or more occur, the UE6 again receives communication information and transmits a request channel RSQ_CH. Specifically, when the UE9 increases a resource use rate to a predetermined ratio or more, the UE9 extends a request channel resource amount (e.g., N+10). The UE6 may randomly select at least one of resources of (N+10) and request allocation of the selected resource to the UE9.

If a resource that the UE6 requests does not collide with a resource that other UE7 and UE8 request at step S230, the UE9 allocates a D2D communication resource to the UE6 through a response channel RSP_CH (S250). Specifically, when periodic allocation is necessary, the UE9 may allocate a periodic resource to the UE6. The UE9 may transmit a response channel RSP_CH in a PDCCH form. A location of a response channel RSP_CH may be mapped one-to-one to a location of a request channel RSQ_CH. When the same resource is overlappingly allocated, there is a problem that an error is continued. In order to avoid this, the UE9 may require a function of managing resource allocation overlapping and listen to a signal of another terminal for a talk-spurt time of a voice.

In order to support a receiving terminal, the UE6 indicates allocation information in an indicator channel IND_CH (S260). Specifically, the UE6 broadcasts an indicator channel IND_CH including information on transmission of data. By transmitting an indicator channel IND_CH, another transmitting terminal as well as the UE6 notifies transmission of data thereof. The UE9 operating as a receiving terminal and a centralized control device may receive an indicator channel IND_CH and determine a presently used data resource.

The UE6 transmits data periodically using an allocated resource (S270 and S280). Specifically, the UE6 broadcasts modulation/demodulation information through a control channel CTR_CH and broadcasts data through a data channel DATA_CH.

A process in which the UE7 that is located out of coverage of the cells 10 and 20 receives data is as follows. Specifically, the UE7 acquires a synchronization signal that the UE9 operating as a centralized control device broadcasts through an uplink. The UE7 receives an indicator channel IND_CH that the UE6 broadcasts and determines an area that is transmitted by the UE6. The UE7 receives a control channel CTR_CH that the UE6 broadcasts and recognizes demodulation information. The UE7 receives a data channel DATA_CH that the UE6 broadcasts.

A release procedure of D2D communication is as follows. Specifically, the UE9 operating as a centralized control device continues to monitor an indicator channel IND_CH and determines a state of a presently used channel. The UE9 determines a channel of which use is released for a predetermined time or more through an indicator channel IND_CH and allocates a channel of which use is released for a predetermined time or more to another UE. For example, when it is determined that the UE6 does not use an allocated data channel DATA_CH for a predetermined time or more, the UE9 may allocate the data channel DATA_CH that is allocated to the UE6 to another UE.

### 4. D2D Communication at Cell Boundary

A D2D communication form at the boundary of cells 10 and 20 will be described in detail.

Even when the UE3 having performed D2D communication in coverage of the cell 10 moves out of coverage of the cell 10, D2D communication should be maintained. For this reason, when the UE3 deviates from a range of the cell 10, the UE3 should be able to receive data using only previously acquired information. When the UE3 having performed D2D communication out of coverage of the cell 10 moves to in coverage of the cell 10, the UE3 should maintain D2D communication, and the UE3 should maintain D2D communication without a collision with D2D communication that the BS1 controls.

A procedure of determining a state in which the UE3 moves from in coverage of the cell 10 to out of coverage of the cell 10 is as follows.

Specifically, when a state of the UE3 is an idle state, the UE3 periodically receives a synchronization signal (e.g., PSS/SSS, Cell specific Reference Signal (CRS), and Physical Broadcast Channel (PBCH)) that the BS1 broadcasts. When intensity of a base station synchronization signal that the UE3 receives is lower than a predetermined reference value, the UE3 determines that the UE3 has deviated from a range of the cell 10. The UE3, having determined that the UE3 has deviated from a range of the cell 10 may perform a cell selection/reselection procedure according to an LTE procedure, and if a cell selection/reselection procedure has failed, the UE3 is finally determined as out of coverage.

When a state of the UE3 is a connected state, if a Radio Link Failure (RLF) occurs between the UE3 and the BS1, the UE3 may determine that the UE3 has deviated from a range of the cell 10. Specifically, while transmitting/receiving data, when an RLF occurs or when intensity of a received signal is lower than a reference range, the UE3 performs an RLF recovery procedure according to an LTE procedure. When an RLF recovery procedure has failed, the UE3 is finally determined as out of coverage.

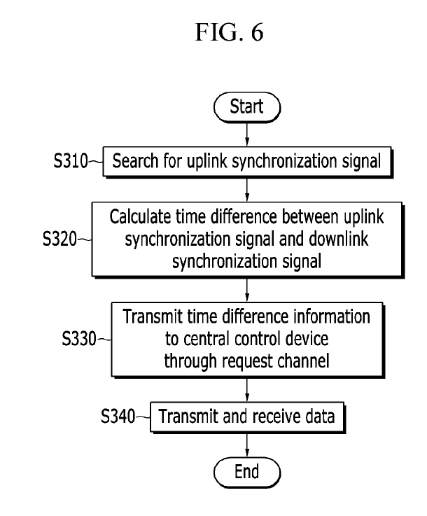

FIG. 6 is a flowchart illustrating a process of transmitting/receiving data when an UE3 having performed D2D communication in coverage of the cell 10 moves out of coverage of the cell 10. For convenience of description, FIG. 6 illustrates a case in which the UE3 recognizes that the UE3 is located out of coverage of the cell 10.

The UE3 searches for an uplink synchronization signal (S310). The uplink synchronization signal may be broadcasted by a centralized control device. The centralized control device may be a terminal.

The UE3 calculates a difference between a time of a downlink synchronization signal (a synchronization signal that the BS1 broadcasts) and a time of an uplink synchronization signal that is acquired at the process S310 (S320). When an uplink synchronization signal is acquired, the UE3 receives an uplink synchronization channel. The uplink synchronization channel may be broadcasted by the centralized control device.

The UE3 indicates a time difference that is calculated at the process S320 in a request channel RSQ_CH, and transmits the time difference to the centralized control device (S330). The centralized control device, having received the request channel RSQ_CH, determines whether to change a synchronization time thereof and responds to the UE3.

When the UE3 receives data, the UE3 receives an indicator channel IND_CH that a transmitting terminal broadcasts using an uplink synchronization signal, and receives a control channel CTR_CH and a data channel DATA_CH corresponding to information that is included in the indicator channel IND_CH (S340).

When the UE3 transmits data, it does so using the above-described procedure in ‘3. D2D communication out of coverage of a cell’ (S340).

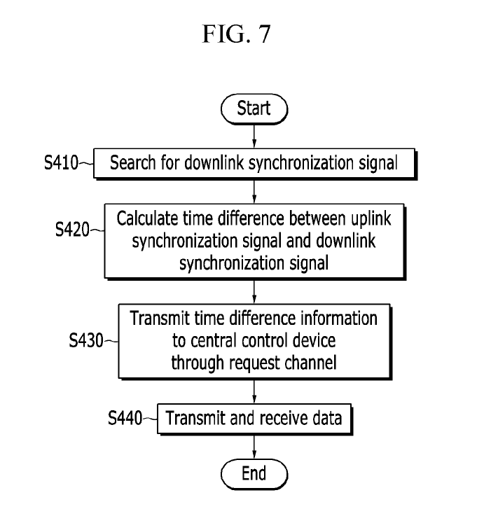

FIG. 7 is a flowchart illustrating a process of transmitting/receiving data when an UE3, having performed D2D communication out of coverage of the cell 10, moves into coverage of the cell 10. For convenience of description, FIG. 7 illustrates a case in which the UE3 recognizes that the UE3 is located in coverage of the cell 10.

The UE3 searches for a downlink synchronization signal that the BS1 broadcasts (S410).

The UE3 calculates a difference between a time of an uplink synchronization signal (a synchronization signal that the BS1 broadcasts) and a time of a downlink synchronization signal that is acquired at the process S410 (S420).

The UE3 indicates a time difference that is calculated at the process S420 in a request channel REQ_CH, and transmits the time difference to the central control device (S430). The central control device may be a terminal. The central control device, having received the request channel REQ_CH, determines whether to change a synchronization time thereof and responds to the UE3.

When the UE3 receives data, the UE3 receives an indicator channel IND_CH that a transmitting terminal broadcasts using a downlink synchronization signal, and receives a control channel CTR_CH and a data channel DATA_CH corresponding to information that is included in the indicator channel IND_CH (S440).

When the UE3 transmits data, it does so using the above-described procedure in ‘2. D2D communication in coverage of a cell’ (S440).

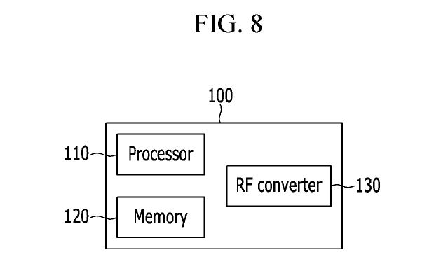

FIG. 8 is a block diagram illustrating a configuration of a terminal 100. The UE1-UE9 may be formed similar to the terminal 100 of FIG. 8.

The terminal 100 includes a processor 110, a memory 120, and a Radio Frequency (RF) converter 130.

The processor 110 may be formed to implement a procedure, a function, and a method related to the above-described UE1-UE9. Further, the processor 110 may be formed to implement a procedure, a function, and a method related to the UE9 operating as the above-described centralized control device.

The memory 120 is connected to the processor 110 and stores various information that is related to operation of the processor 110.

The RF converter 130 is connected to the processor 110 and transmits/receives a wireless signal. The terminal 100 may have a single antenna or multiple antennas.

In the foregoing description, a case in which a centralized control device is generally a terminal is illustrated, but this is only an illustration. The centralized control device may be a device or a base station instead of a terminal.

According to an exemplary embodiment of the present invention, in a structure in which a terminal receives control of a mobile communication base station, the terminal can perform D2D communication.

Further, according to an exemplary embodiment of the present invention, even when a terminal is located at a cell boundary or is located out of coverage of a cell boundary, the terminal can perform D2D communication.

In addition, according to an exemplary embodiment of the present invention, in D2D communication of a centralized control method, as a base station or a centralized control device performs a synchronization management and D2D communication management function of a terminal, stable transmission performance can be provided, consistent D2D communication management can be provided, and power consumption of a terminal can be efficiently reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A Device-to-Device (D2D) communication method in which a first terminal within a first cell of a first base station directly communicates with a second terminal without relay of the first base station, the D2D communication method comprising:
receiving a synchronization signal and a synchronization channel that are broadcasted through a downlink by the first base station;
acquiring synchronization for D2D communication using the synchronization signal and the synchronization channel;
transmitting first information for D2D communication to the first base station through a first data channel for cellular communication in order to request allocation of a first resource for D2D communication, when the first terminal is connected to the first base station;
receiving D2D control information comprising information about the first resource that is allocated to the first terminal from the first base station; and
broadcasting a second data channel for D2D communication using the D2D control information.

2. The D2D communication method of claim 1, wherein the first information comprises:
at least one of a first identifier of the first terminal and a second identifier of a first group to which the first terminal belongs;
information about the first resource that the first terminal is to use; and
information about a size of data that the first terminal is to transmit.

3. The D2D communication method of claim 2, wherein the transmitting of first information comprises transmitting a Buffer Status Report (BSR) message comprising the first information to the first base station.

4. The D2D communication method of claim 3, wherein the D2D control information comprises:
at least one of the first identifier and the second identifier;
at least one of a location of the first resource, a size of the first resource, and the number of the first resource; and
at least one of a repetition cycle of the first resource and the repetition number of the first resource.

5. The D2D communication method of claim 4, wherein the receiving of D2D control information comprises receiving the D2D control information from the first base station through at least one of a first control channel and a first response channel for a downlink.

6. The D2D communication method of claim 5, further comprising transmitting the first information to the first base station through a third data channel after the first terminal is randomly accessed to the first base station through a random access channel, when a state of the first terminal is an idle state.

7. The D2D communication method of claim 6, wherein the receiving of D2D control information further comprises:
determining whether the D2D control information is information for the first terminal using the first identifier that is included in the D2D control information, when the first terminal is connected to the first base station; and
determining whether the D2D control information is information for the first terminal using the second identifier that is included in the D2D control information, when a state of the first terminal is an idle state.

8. The D2D communication method of claim 5, wherein the broadcasting of a second data channel comprises:
broadcasting a first indicator channel comprising information on whether the first terminal transmits first data using the second data channel;
broadcasting a second control channel for demodulating the first data; and
broadcasting the second data channel in order to broadcast the first data.

9. The D2D communication method of claim 1, wherein the receiving of D2D control information comprises:
receiving, when the second terminal is located in coverage of a second cell of a second base station, the D2D control information further comprising second information about the difference between a synchronization time that the first base station uses and a synchronization time that the second base station uses from the first base station; and
changing a synchronization time using the second information.

10. A method in which a first terminal controls Device-to-Device (D2D) communication between terminals, the method comprising:
broadcasting a first synchronization signal and a first synchronization channel through an uplink, when the first terminal operates as a centralized control device that manages synchronization and a resource for D2D communication;
receiving a first message that requests allocation of a first resource for D2D communication from a second terminal; and
allocating the first resource to the second terminal,
wherein the first synchronization channel comprises information about a first identifier of the first terminal and a type of the first synchronization signal.

11. The method of claim 10, wherein the first synchronization channel further comprises at least one of information representing that the first synchronization channel is a channel for synchronization of D2D communication, information representing the first synchronization signal, information about accuracy of the first synchronization signal, information representing that the first terminal is a moving device, a moving speed of the first terminal, change information of a synchronization time for the first synchronization signal, location information of the first terminal, intensity of the first synchronization signal, and the number of terminals using the first synchronization signal.

12. The method of claim 11, wherein the broadcasting of a first synchronization signal comprises:
receiving, when the second terminal does not receive a second synchronization signal that is broadcasted through a downlink by a base station, broadcasting instruction for the first synchronization signal from the base station; and
operating as the centralized control device in response to the broadcasting instruction.

13. The method of claim 11, wherein the broadcasting of a first synchronization signal comprises:
broadcasting, when receiving a second synchronization signal that is broadcasted through a downlink by a base station, the first synchronization signal based on the second synchronization signal;
broadcasting, when receiving a Global Positioning System (GPS) signal instead of receiving the second synchronization signal, the first synchronization signal based on the GPS signal;
broadcasting, when receiving a third synchronization signal that another centralized control device broadcasts instead of receiving the second synchronization signal and the GPS signal, the first synchronization signal based on the third synchronization signal; and
broadcasting, when not receiving the second synchronization signal, the GPS signal, and the third synchronization signal, the first synchronization signal based on a randomly predetermined time.

14. The method of claim 11, further comprising:
transmitting, when receiving a second synchronization signal and a second synchronization channel that another centralized control device broadcasts, information about the second synchronization signal and the second synchronization channel to a base station; and
stopping broadcasting the first synchronization signal, when receiving a broadcasting stop instruction from the base station.

15. The method of claim 11, wherein the broadcasting of a first synchronization signal comprises:
receiving a second message representing that the second terminal, having received the first synchronization signal and the first synchronization channel, accesses to the first terminal, from the second terminal; and
counting the number of terminals using the first synchronization signal based on the second message.

16. The method of claim 11, further comprising:
changing, when receiving a second synchronization signal that is broadcasted through a downlink by a base station, a synchronization time for the first synchronization signal based on the second synchronization signal; and
reporting information about the first terminal operating as the centralized control device to the base station so that the base station determines whether the first terminal is to continue to operate as the centralized control device.

17. A device-to-device (D2D) communication method in which a first terminal directly communicates with a second terminal without relay of a first base station, the D2D communication method comprising:
receiving a first synchronization signal and a first synchronization channel from a third terminal operating as a centralized control device that manages synchronization and a resource for D2D communication, when the first terminal is located out of coverage of a first cell of the first base station;
transmitting a Buffer Status Report (BSR) message to the third terminal through a request channel for requesting resource allocation, when receiving the first synchronization signal and the first synchronization channel;
receiving information about a first resource that is allocated to the first terminal from the third terminal through a response channel; and
broadcasting a first indicator channel comprising information on whether the first terminal transmits first data using the first resource.

18. The D2D communication method of claim 17, further comprising determining that the first terminal is located out of coverage of the first cell, when receiving intensity of a second synchronization signal that is broadcasted through a downlink by the first base station is a first threshold value or less or when a Radio Link Failure (RLF) occurs between the first terminal and the first base station.

19. The D2D communication method of claim 18, wherein the receiving of a first synchronization signal comprises calculating the difference between a synchronization time for the first synchronization signal and a synchronization time for the second synchronization signal, and
the transmitting of a BSR message comprises transmitting the request channel comprising information about the synchronization time difference to the third terminal.

20. The D2D communication method of claim 18, further comprising:
determining that the first terminal is located in coverage of the first cell, when receiving intensity of the second synchronization signal is larger than the first threshold value;
calculating the difference between a synchronization time for the first synchronization signal and a synchronization time for the second synchronization signal and transmitting the difference to the third terminal, when the first terminal is located in coverage of the first cell; and
changing a synchronization time using the second synchronization signal.
